(19) United States
(12) Patent Application Publication
(10) Pub. No.: US 2023/0245299 A1
(43) Pub. Date: Aug. 3, 2023

(54) PART INSPECTION SYSTEM HAVING ARTIFICIAL NEURAL NETWORK

(71) Applicant: TE Connectivity Solutions GmbH, Schaffhausen (CH)

(72) Inventor: Peter John Borisuk, Berwyn, PA (US)

(21) Appl. No.: 18/159,648

(22) Filed: Jan. 25, 2023

Related U.S. Application Data
(60) Provisional application No. 63/303,050, filed on Feb. 3, 2022.

(51) Int. Cl. G06T 7/00; G06T 7/70

(52) U.S. Cl. CPC G06T 7/001; G06T 7/70; G06T 2207/20081; G06T 2207/20084; G06T 2207/30164

(57) ABSTRACT

A terminal inspection system for a crimp machine includes a vision device configured to image a terminal being inspected and generate a digital image of the terminal. The terminal inspection system includes a terminal inspection module communicatively coupled to the vision device to receive the digital image of the terminal as an input image. The terminal inspection module has an anchor image. The terminal inspection module compares the input image to the anchor image and performs semantic segmentation between the input image and the anchor image to generate an output image. The output image shows differences between the input image and the anchor image to identify any potential defects.

### CROSS REFERENCE TO RELATED APPLICATIONS

This application claims benefit to U.S. Patent Application No. 63/303,050, filed Feb. 3, 2022, the subject matter of which is herein incorporated by reference in its entirety.

### BACKGROUND OF THE INVENTION

The subject matter herein relates generally to terminal inspection systems and methods.

With the development of image processing technologies, image processing technologies have been applied to defect detection in manufactured products. In practical applications, after one or more manufacturing steps, parts may be imaged and the images analyzed to detect for defects, such as prior to assembly of the part or shipment of the part. Some defects are difficult for known image processing systems to identify. Additionally, training of the image processing system may be difficult and time consuming. For example, training typically involves gathering many images including both good and bad images, such as images of parts that do not include defects and images of parts that do have defects, respectively. The system is trained by analyzing both the good and bad images. However, it is not uncommon to have an insufficient number of images for training, such as few bad images to train the system with the various types of defects. The algorithm used to operate the system for defect detection performs poorly. Accuracy of the inspection system is affected by poor training of the system.

A need remains for a robust terminal inspection system and method.

### BRIEF DESCRIPTION OF THE INVENTION

In one embodiment, a terminal inspection system for a crimp machine is provided and includes a vision device configured to image a terminal being inspected and generate a digital image of the terminal. The terminal inspection system includes a terminal inspection module communicatively coupled to the vision device to receive the digital image of the terminal as an input image. The terminal inspection module has an anchor image. The terminal inspection module compares the input image to the anchor image and performs semantic segmentation between the input image and the anchor image to generate an output image. The output image shows differences between the input image and the anchor image to identify any potential defects.

In another embodiment, a crimp machine is provided and includes an anvil having a terminal support surface at a crimp zone configured to support a terminal during a crimping operation. The crimp machine includes a press that has an actuator, a ram operably coupled to the actuator, and a crimp die coupled to the ram. The actuator moves the ram in a pressing direction during the crimping operation to move the crimp die relative to the anvil. The crimp die has a forming surface configured to crimp the terminal in the crimp zone during the crimping operation. The crimp machine includes a terminal inspection system including a vision device and a terminal inspection module communicatively coupled to the vision device. The vision device is configured to image the terminal at the crimp zone and generate a digital image of the terminal. The terminal inspection module receives the digital image of the terminal as an input image. The terminal inspection module has an anchor image. The terminal inspection module compares the input image to the anchor image and performs semantic segmentation between the input image and the anchor image to generate an output image. The output image shows differences between the input image and the anchor image to identify any potential defects.

In a further embodiment, a terminal inspection method is provided and includes imaging a terminal using a vision device to generate an input image. The terminal inspection method compares the input image to an anchor image. The terminal inspection method performs semantic segmentation between the input image and the anchor image. The terminal inspection method generates an output image to show differences between the input image and the anchor image to identify any potential defects.

### BRIEF DESCRIPTION OF THE DRAWINGS

FIG. 1 illustrates a part inspection system in accordance with an exemplary embodiment.

FIG. 2 is a perspective view of the terminal inspection system in accordance with an exemplary embodiment.

FIG. 3 illustrates an anchor image of the crimp zone in accordance with an exemplary embodiment.

FIG. 4 illustrates a “bad” input image of the crimp zone in accordance with an exemplary embodiment showing a defect in the form of a foreign object in the crimp barrel of the terminal.

FIG. 5 illustrates a “bad” input image of the crimp zone in accordance with an exemplary embodiment showing a defect in the form of the terminal improperly positioned in the crimp zone.

FIG. 6 illustrates a “bad” input image of the crimp zone in accordance with an exemplary embodiment showing a defect in the form of an improperly shaped terminal in the crimp zone.

FIG. 7 is a schematic illustration of the terminal inspection module in accordance with an exemplary embodiment.

FIG. 8 illustrates a training data set for training the terminal inspection module using the image comparison tool in accordance with an exemplary embodiment.

FIG. 9 illustrates a training data set for training the terminal inspection module using the image comparison tool in accordance with an exemplary embodiment.

FIG. 10 illustrates a training data set for training the terminal inspection module using the image comparison tool in accordance with an exemplary embodiment.

FIG. 11 illustrates a training data set for training the terminal inspection module using the image comparison tool in accordance with an exemplary embodiment.

FIG. 12 illustrates a training data set \ for training the terminal inspection module \ using the image comparison tool in accordance with an exemplary embodiment.

FIG. 13 is a flow chart of a terminal inspection method in accordance with an exemplary embodiment.

### DETAILED DESCRIPTION OF THE INVENTION

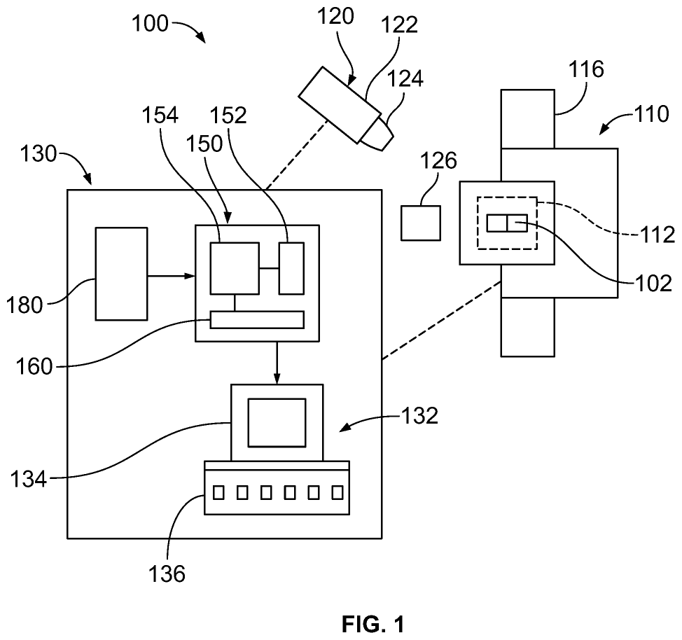

FIG. 1 illustrates a part inspection system 100 in accordance with an exemplary embodiment. The part inspection system 100 is used to inspect parts 102 for defects, such as defects with the part itself or defects with loading or positioning of the part in a processing machine. In an exemplary embodiment, the part inspection system 100 is a vision inspection system using one or more processors to analyze digital images of the part 102 for defects. In an exemplary embodiment, the part inspection system 100 uses an artificial neural network architecture for defect detection.

In an exemplary embodiment, the part inspection system 100 compares the digital image of the part (for example, input image) to an anchor image (for example, baseline or template or “good” image). The part inspection system 100 generates an output image to show defects, if any are present. For example, the output image may highlight differences between the input image and the anchor image. In an exemplary embodiment, the part inspection system 100 performs a pixel-by-pixel comparison of the input image and the anchor image to generate the output image. In various embodiments, the part inspection system 100 performs a semantic segmentation between the input image and the anchor image. The terminal inspection system 100 may be used to analyze the digital images for one particular type of defect or for multiple, different types of defects.

In various embodiments, the part 102 may be an electrical terminal and may be referred to hereinafter as a terminal 102 and the system 100 may correspondingly be referred to hereinafter as a terminal inspection system 100. The terminal 102 may be a crimp terminal and the terminal inspection system 100 images the crimp barrel of the crimp terminal. A wire or cable may be received in the crimp barrel. The terminal inspection system 100 may image the crimp barrel prior to or after the wire or cable is received in the crimp barrel and/or after the crimping process. The terminal 102 may be a power terminal configured to be terminated (for example, crimped) to a power cable. The system 100 may image other types of parts in alternative embodiments, such as an electrical connector, a printed circuit board, or another type of electrical component. The terminal inspection system 100 may be used to inspect other types of parts in alternative embodiments.

The inspection system 100 is located at a part processing station 110. The processing station 110 is used to process the part, such as forming, connecting, attaching, assembling or otherwise processing the part 102. In various embodiments, the part processing station 110 includes one or more machines at a processing station, such as a press machine, a crimping machine, a stamping machine, a drill press, a cutting machine, a loader, an assembly machine, and the like for processing the part 102. The inspection system 100 inspects the part 102 at the processing station 110, such as at an inspection zone 112. In various embodiments, the processing station 110 is a crimp machine and the inspection zone 112 is at a crimping zone of the crimp machine.

In an exemplary embodiment, the processing station 110 may include a manipulator 116 for moving the part 102 relative to the processing station 110. For example, the manipulator 116 may include a feeder, a conveyor, a vibration tray, or another type of part manipulator for moving the part 102 into, within, or out of the processing station 110. In various embodiments, the manipulator 116 may include a feeder device, such as a feed finger used to advance the part 102, which is held on a carrier, such as a carrier strip. In other various embodiments, the manipulator 116 may include a multi-axis robot configured to move the part 102 in three-dimensional space within the processing station 110. In other alternative embodiments, the part 102 may be manually manipulated and positioned at the inspection zone 112 by hand.

The terminal inspection system 100 includes a vision device 120 for imaging the terminal 102 at the inspection zone 112. The vision device 120 may be mounted to a frame or other structure of the processing station 110. The vision device 120 includes a camera 122 used to image the terminal 102. The camera 122 may be movable within the inspection zone 112 relative to the terminal 102 (or the terminal 102 may be movable relative to the camera 122) to change a working distance between the camera 122 and the terminal 102, which may affect the clarity of the image. Other types of vision devices may be used in alternative embodiments, such as an infrared camera, or other type of camera that images at wavelengths other than the visible light spectrum.

In an exemplary embodiment, the terminal inspection system 100 includes a lens 124 at the camera 122 for controlling imaging. The lens 124 may be used to focus the field of view. The lens 124 may be adjusted to change a zoom level to change the field of view. The lens 124 is operated to adjust the clarity of the image, such as to achieve high quality images.

In an exemplary embodiment, the terminal inspection system 100 includes a lighting device 126 to control lighting conditions in the field of view of the vision device 120 at the inspection zone 112. The lighting device 126 may be adjusted to control properties of the lighting, such as brightness, light intensity, light color, and the like. The lighting affects the quality of the image generated by the vision device 120.

In an exemplary embodiment, the vision device 120 is operably coupled to a controller 130. The vision device 120 generates digital images and transmits the digital images to the controller 130 as input images. The controller 130 includes or may be part of a computer in various embodiments. In an exemplary embodiment, the controller 130 includes a user interface 132 having a display 134 and a user input 136, such as a keyboard, a mouse, a keypad, or another type of user input.

In an exemplary embodiment, the controller 130 is operably coupled to the vision device 120 and controls operation of the vision device 120. For example, the controller 130 may cause the vision device 120 to take an image or retake an image. In various embodiments, the controller 130 may move the camera 122 to a different location, such as to image the terminal 102 from a different angle. The controller 130 may be operably coupled to the lens 124 to change the imaging properties of the vision device 120, such as the field of view, the focus point, the zoom level, the resolution of the image, and the like. The controller 130 may be operably coupled to the lighting device 126 to change the imaging properties of the vision device 120, such as the brightness, the intensity, the color or other lighting properties of the lighting device 126.

In an exemplary embodiment, the controller 130 is operably coupled to the processing station 110, such as to control the processing machine or device. For example, the controller 130 may control the crimping operation, such as to operate the ram or press during the crimping processes. In various embodiments, the controller 130 may be operably coupled to the manipulator 116 to control operation of the manipulator 116. For example, the controller 130 may cause the manipulator 116 to move the terminal 102 into, within, or out of the processing station 110. The controller 130 may cause the manipulator 116 to move the terminal 102 within the processing station 110, such as to move the terminal 102 relative to the camera 122.

The processing station 110 includes a terminal inspection module 150 operably coupled to the controller 130. In various embodiments, the terminal inspection module 150 may be embedded in the controller 130 or the terminal inspection module 150 and the controller 130 may be integrated into a single computing device. The terminal inspection module 150 receives the digital image of the terminal 102 from the vision device 120 as an input image. The terminal inspection module 150 analyzes the digital image and generates outputs based on the analysis. The output is used to indicate to the user whether or not the terminal has any defects. In an exemplary embodiment, the terminal inspection module 150 includes one or more memories 152 for storing data and/or executable instructions and one or more processors 154 configured to execute the executable instructions stored in the memory 152 to inspect the terminal 102. In various embodiments, the memories 152 may store anchor images (for example, baseline or template or “good” images) of the parts 102 for comparison and analysis.

In an exemplary embodiment, the terminal inspection module 150 includes an image comparison tool 160. The controller 130 sends the input image and the corresponding anchor image to the image comparison tool 160 for analysis. The image comparison tool 160 compares the input image with the anchor image to determine if the terminal has any defects. In an exemplary embodiment, the image comparison tool 160 performs a semantic segmentation between the input image and the anchor image to identify defects. For example, the image comparison tool 160 performs a pixel-by-pixel comparison of the input image and the anchor image. In an exemplary embodiment, the image comparison tool 160 performs image subtraction between the input image and the anchor image to identify differences corresponding to defects, if any. The image comparison tool 160 may performs an absolute image difference between the input image and the anchor image to identify differences corresponding to defects, if any. The image comparison tool 160 may include a matching algorithm for matching the input image to the anchor image to identify differences corresponding to defects.

The terminal inspection module 150 generates an output image based on processing by the image comparison tool 160. The output image highlights differences between the input image and the anchor image. For example, the output image may highlight differences by displaying pixels without differences with a first color (for example, black pixels) in the output image and displaying pixels with differences with a second color (for example, white pixels) in the output image. The output image may overlay one or more defect identifiers on the output image at any identified defect locations. For example, the defect identifiers may be bounding boxes or other types of identifiers. If no defects are detected, then the output image does not include any defect identifiers. For example, the output image may be a single color (for example, black). The image comparison tool 160 may filter the data to remove noise for the output image.

In an exemplary embodiment, the image comparison tool 160 of the terminal inspection module 150 may include an artificial neural network architecture for image comparison. For example, the image comparison tool 160 of the terminal inspection module 150 may include a U-net network architecture or another type of network architecture, such as a truncated U-net or an alternate NN architecture, to compare the input image and the anchor image to generate the output image. In other various embodiments, the terminal inspection module may use a binary classifier architecture. In an exemplary embodiment, the one or more of the memories 152 of the terminal inspection module 150 stores the neural network architecture. The neural network architecture may have a plurality of convolutional layers, a plurality of pooling layers, and an output layer. The one or more processors 154 associated with the terminal inspection module 150 are configured to analyze the digital image through the layers of the neural network architecture. In an exemplary embodiment, the neural network architecture is stored as executable instructions in the memory 152. The processor 154 uses the neural network architecture by executing the stored instructions. In an exemplary embodiment, the neural network architecture may be a machine learning artificial intelligence (AI) module.

In an exemplary embodiment, the controller 130 includes or is coupled to a training module 180 for training the terminal inspection module 150. In various embodiments, the training module 180 may be part of the controller 130 such that training is performed on the controller 130 (for example, using internal processors). In other embodiments, the training module 180 may be performed on another machine separate from the controller 130 and the training data is communicated to the controller 130. The training module 180 includes a training data set to train the terminal inspection module 150. The training data set may include one or more anchor images, such as anchor images of different parts that may be processed at the processing station 110. The training data set may include a plurality of positive images and a plurality of negative images. The positive images represent “good” images and are used to train the terminal inspection module 150 various features or characteristics that are acceptable to pass the images as being good images. For example, the terminal inspection module 150 may be trained to ignore certain types of differences when highlighting differences in the output image. In various embodiments, differences relating to the materials of the parts or the background structures between the input image and the anchor image may be ignored. In various embodiments, differences relating to positional differences between the parts and the background structures between the input image and the anchor image may be ignored. There may be angular or positional allowances or limits to such positional differences which may be trained by the training module 180. The negative images represent “bad” images and are used to train the terminal inspection module 150 various features or characteristics that are unacceptable, and thus fail the images as being bad images. For example, the terminal inspection module 150 may be trained to focus on certain types of differences when highlighting differences in the output image. In various embodiments, differences in the shape of the part in the input image and the anchor image may be important and highlighted in the output image. In various embodiments, differences relating to foreign objects in or around the part in the input image may be important and highlighted in the output image. In an exemplary embodiment, the training data set may be based on digitally generated images rather than actual images of actual parts. As such, the training may be accomplished quickly and easily with less operator training time. The processing time of the system may be reduced compared to systems that use other types of neural networks.

During operation of the terminal inspection module 150, the terminal inspection module 150 runs programs to analyze the image. For example, the terminal inspection module 150 operates programs stored in the memory 152 on the processor 154. The processor 154 may include computer system executable instructions, such as program modules, being executed by a computer system. Generally, program modules may include routines, programs, objects, components, logic, data structures, and so on that perform particular tasks or implement particular abstract data types. The computing may be practiced in distributed cloud computing environments where tasks are performed by remote processing devices that are linked through a communications network. In a distributed cloud computing environment, program modules may be located in both local and remote computer system storage media including memory storage devices.

In an exemplary embodiment, various components may be communicatively coupled by a bus, such as the memory 152 and the processors 154. The bus represents one or more of any of several types of bus structures, including a memory bus or memory controller, a peripheral bus, an accelerated graphics port, and a processor or local bus using any of a variety of bus architectures.

The terminal inspection module 150 may include a variety of computer system readable media. Such media may be any available media that is accessible by the terminal inspection module 150, and it includes both volatile and non-volatile media, removable and non-removable media. The memory 152 can include computer system readable media in the form of volatile memory, such as random-access memory (RAM) and/or cache memory. The terminal inspection module 150 may further include other removable/non-removable, volatile/non-volatile computer system storage media. By way of example only, a storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. The memory 152 may include at least one program product having a set (e.g., at least one) of program modules that are configured to carry out the functions of embodiments of the invention.

One or more programs may be stored in the memory 152, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the subject matter described herein.

The terminal inspection module 150 may also communicate with one or more external devices, such as through the controller 130. The external devices may include a keyboard, a pointing device, a display, and the like; one or more devices that enable a user to interact with system; and/or any devices (e.g., network card, modem, etc.) that enable the system to communicate with one or more other computing devices. Such communication can occur via Input/Output (I/O) interfaces. Still yet, terminal inspection module 150 can communicate with one or more networks such as a local area network (LAN), a general wide area network (WAN), and/or a public network (e.g., the Internet) via network adapter. Other hardware and/or software components could be used in conjunction with the system components shown herein. Examples, include, but are not limited to microcode, device drivers, redundant processing units, and external disk drive arrays, RAID systems, tape drives, and data archival storage systems, etc.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 154, memory 152, and input/output interface can be interconnected, for example, via the bus as terminal of a data processing unit. Suitable interconnections, for example via bus, can also be provided to a network interface, such as a network card, which can be provided to interface with a computer network, and to a media interface, such as a diskette or CD-ROM drive, which can be provided to interface with suitable media.

Accordingly, computer software including instructions or code for performing the methodologies of the subject matter herein may be stored in one or more of the associated memory devices (for example, ROM, fixed or removable memory) and, when ready to be utilized, loaded in terminal or in whole (for example, into RAM) and implemented by a CPU. Such software could include, but is not limited to, firmware, resident software, microcode, and the like.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

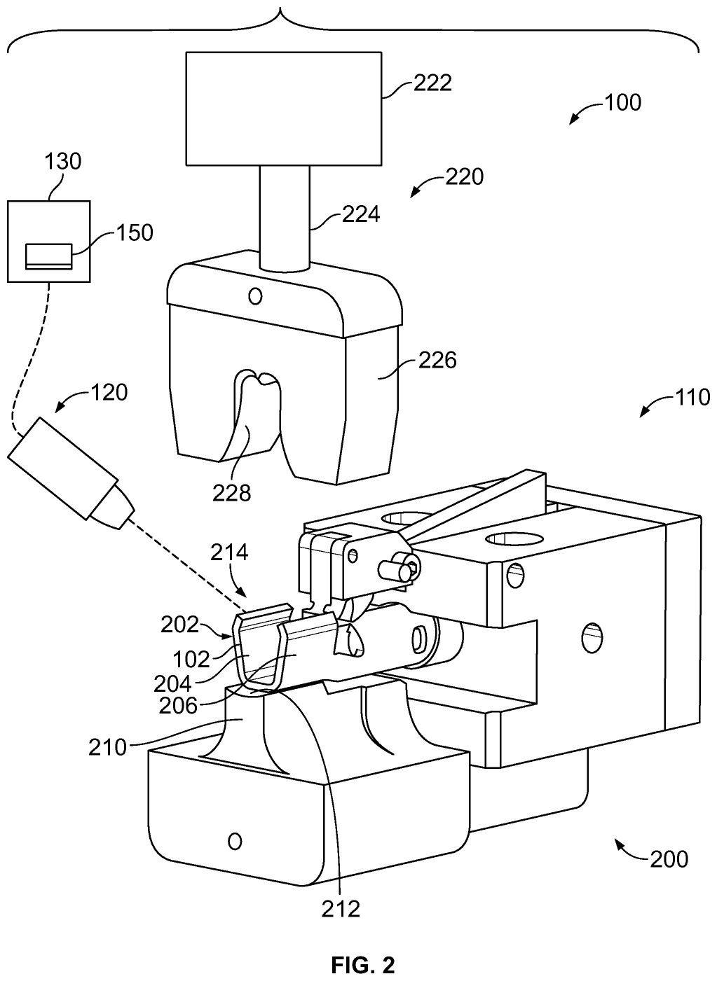

FIG. 2 is a perspective view of the terminal inspection system 100 in accordance with an exemplary embodiment. The terminal inspection system 100 is used for inspecting the terminal 102 at the crimping zone. The terminal inspection system 100 is used with a crimp machine 200 at the processing station 110. The crimp machine 200 is used to crimp the terminal 102 to a wire or cable (not shown). The terminal 102 includes a crimp barrel 202 having arms 204, 206 configured to be crimped around the cable by the crimp machine 200. In an exemplary embodiment, the vision device 120 images the terminal 102 prior to the crimping operation. The vision device 120 may additionally or alternatively image the terminal 102 after the crimping operation.

The crimp machine 200 includes an anvil 210 having a terminal support surface 212 at a crimp zone 214. The terminal support surface 212 supports the terminal 102 during the crimping operation. The terminal support surface 212 may be flat. Alternatively, the terminal support surface 212 may be curved to position the terminal 102 in the crimp zone 214.

The crimp machine 200 includes a press 220 having an actuator 222 and a ram 224 operably coupled to the actuator 222. The press 220 includes a crimp die 226 coupled to the ram 224. The actuator 222 moves the ram 224 in a pressing direction (for example, downward) during the crimping operation to move the crimp die 226 relative to the anvil 210. The crimp die 226 has a forming surface 228 configured to crimp the arms 204, 206 of the terminal 102 to the cable in the crimp zone 214 during the crimping operation. The crimp die 226 may form an F-crimp in various embodiments.

The terminal inspection system 100 images the terminal 102 to inspect the terminal 102 for defects, such as defects with the terminal itself or defects with loading or positioning of the part in a processing machine. For example, the crimp barrel 202 of the terminal 102 may be imaged to determine that the correct type of terminal 102 is positioned in the crimp zone 214 and/or the correct size of terminal 102 is positioned in the crimp zone 214 and/or the terminal 102 is properly positioned on the terminal support surface 212. The image of the terminal 102 is fed to the terminal inspection module 150 as an input image and compared to an anchor image to identify defects (for example, to identify differences). The defects are output and may be used to control the crimping operation. For example, the defects may be identified on an output image which is presented to an operator. The operator may determine if the crimping operation should proceed or cease based on the output image. For example, if differences are identified, the operator may stop the crimping operation, such as to reposition the terminal 102 or change out the terminal 102. In various embodiments, the output may be used by the controller 130 to automatically control the crimping operation, such as without operator intervention. For example, the crimping process may automatically proceed if no defects are identified (for example, no differences between the input image and the anchor image). The terminal may be automatically repositioned or removed if defects are identified (for example, differences are highlighted between the input image and the anchor image).

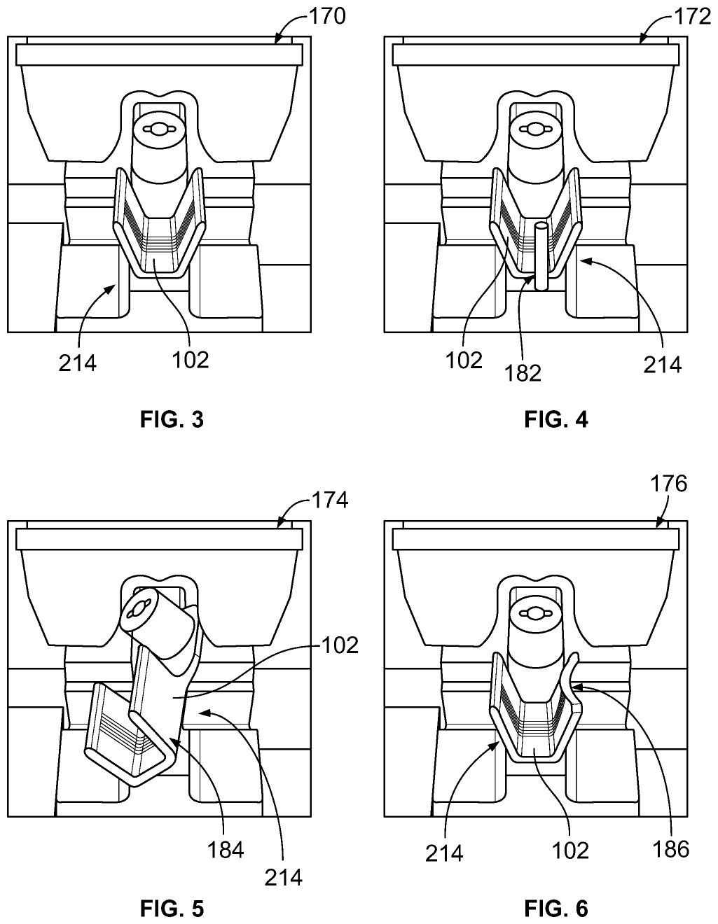

FIG. 3 illustrates an anchor image 170 of the crimp zone 214 in accordance with an exemplary embodiment. FIG. 4 illustrates a “bad” input image 172 of the crimp zone 214 in accordance with an exemplary embodiment showing a defect 182 in the form of a foreign object in the crimp barrel of the terminal. FIG. 5 illustrates a “bad” input image 174 of the crimp zone 214 in accordance with an exemplary embodiment showing a defect 184 in the form of the terminal improperly positioned in the crimp zone. FIG. 6 illustrates a “bad” input image 176 of the crimp zone 214 in accordance with an exemplary embodiment showing a defect 186 in the form of an improperly shaped terminal in the crimp zone. The terminal inspection system 100 is configured to identify the defects by comparing the images to the anchor image (FIG. 3) and highlighting the differences (the defect) in an output image.

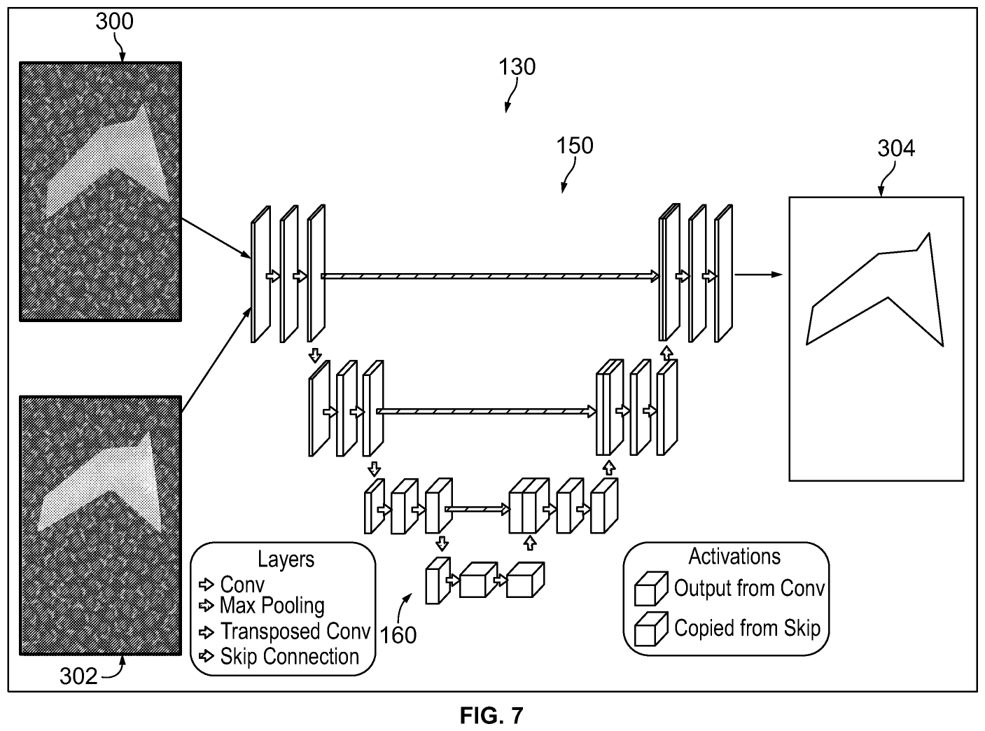

FIG. 7 is a schematic illustration of the terminal inspection module 150 in accordance with an exemplary embodiment. FIG. 7 shows an input image 300, an anchor image 302 and an output image 304. FIG. 7 shows an exemplary image comparison tool 160 used to compare the input image 300, the anchor image 302 and the output image 304. In the illustrated embodiment, the image comparison tool 160 is a U-net network architecture comparing the input image 300 and the anchor image 302 to generate the output image 304. However, the image comparison tool 160 may use other image comparison techniques or neural networks to compare the images and generate an output image. In various embodiments, the image comparison tool 160 may perform a semantic segmentation between the input image 300 and the anchor image 302 to identify defects. For example, the image comparison tool 160 performs a pixel-by-pixel comparison of the input image 300 and the anchor image 302.

The image comparison tool 160 compares the input image 300 with the anchor image 302 to determine if the part/terminal has any defects. The terminal inspection module 150 generates the output image 304 based on processing by the image comparison tool 160. The output image 304 highlights differences between the input image 300 and the anchor image 302. For example, the output image 304 may highlight differences by displaying pixels without differences with a first color (for example, black pixels) in the output image 304 and displaying pixels with differences with a second color (for example, white pixels) in the output image 304.

The output image may overlay one or more defect identifiers on the output image at any identified defect locations. For example, the defect identifiers may be bounding boxes or other types of identifiers. If no defects are detected, then the output image does not include any defect identifiers. For example, the output image may be a single color (for example, black).

The terminal inspection module 150 may ignore certain types of differences when highlighting differences in the output image 304. In various embodiments, differences relating to the materials of the parts or the background structures between the input image 300 and the anchor image 302 may be ignored. In various embodiments, differences relating to positional differences of the parts between the input image 300 and the anchor image 302 may be ignored. However, there may be angular or positional allowances or limits to such positional differences which may be trained by the training module 180.

The terminal inspection module 150 may be trained to focus on certain types of differences to highlight and identify as defects. In various embodiments, differences in the shape of the part in the input image 300 and the anchor image 302 may be important and highlighted in the output image. In various embodiments, differences relating to foreign objects in or around the part in the input image 300 may be important and highlighted in the output image 304.

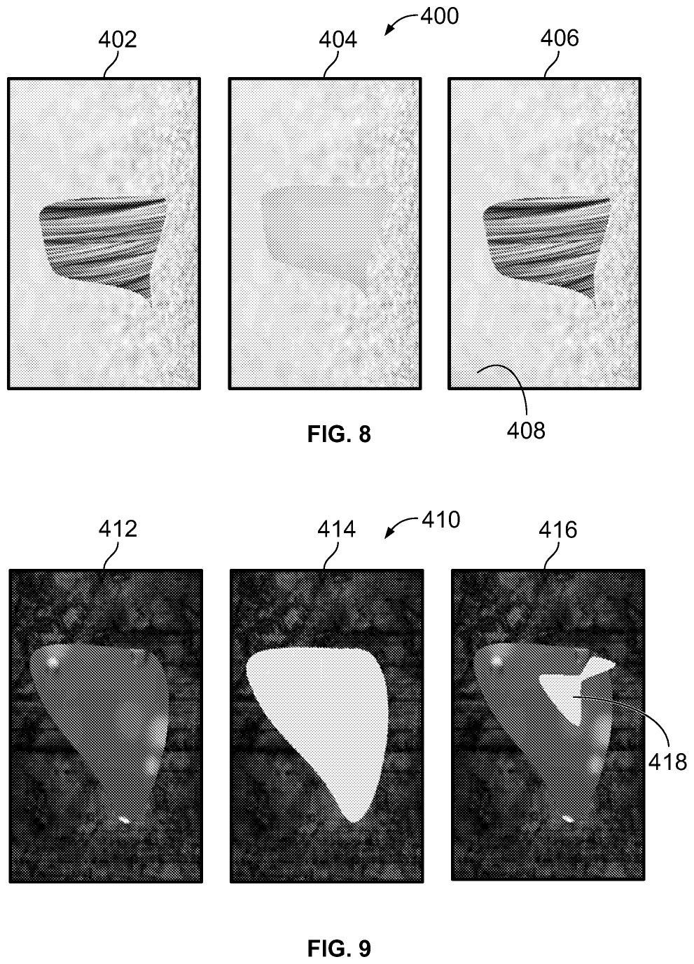

In an exemplary embodiment, the controller 130 uses the training module 180 (FIG. 1) for training the terminal inspection module 150. The training module may supply the training data sets (examples of training data sets are shown in FIGS. 8-12) to the image comparison tool 160 to train the terminal inspection module 150. Each training data set includes an anchor image, a positive input image and a negative input image. The image comparison tool 160 analyzes the anchor image compared to the positive input image and then analyzes the anchor image compared to the negative input image. Many training data sets may be analyzed by the image comparison tool 160 to train the terminal inspection module 150.

FIG. 8 illustrates a training data set 400 for training the terminal inspection module 150 using the image comparison tool 160 (shown in FIG. 7). The training data set 400 includes an anchor image 402, a positive (“good”) input image 404, and a negative (“bad”) input image 406.

In various embodiments, differences relating to the materials of the parts or the background structures between the input image 404 and the anchor image 402 may be ignored. In the illustrated embodiment, the material of the part is different in the positive input image 404, which is used to train the image comparison tool 160 to ignore differences relating to material of the part.

In various embodiments, differences relating to positional differences of the parts between the input image 404 and the anchor image 402 may be ignored. In the illustrated embodiment, the position of the part in the input image 404 is shown shifted slightly upward relative to the position of the part in the anchor image 402, which is used to train the image comparison tool 160 to ignore positional differences of the part relative to the background structure.

In various embodiments, differences relating to foreign objects in or around the part in the input image 406 may be important. In the illustrated embodiment, a foreign object 408 is shown in the negative input image 406, which is used to train the image comparison tool 160 to highlight differences relating to foreign objects.

FIG. 9 illustrates a training data set 410 for training the terminal inspection module 150 using the image comparison tool 160 (shown in FIG. 7). The training data set 410 includes an anchor image 412, a positive (“good”) input image 414, and a negative (“bad”) input image 416.

In various embodiments, differences relating to the materials of the parts or the background structures between the input image 414 and the anchor image 412 may be ignored. In the illustrated embodiment, the material of the part is different in the positive input image 414, which is used to train the image comparison tool 160 to ignore differences relating to material of the part.

In various embodiments, differences relating to positional differences of the parts between the input image 414 and the anchor image 412 may be ignored. In the illustrated embodiment, the position of the part in the input image 414 is shown shifted slightly upward relative to the position of the part in the anchor image 412, which is used to train the image comparison tool 160 to ignore positional differences of the part relative to the background structure.

In various embodiments, differences relating to foreign objects in or around the part in the input image 416 may be important. In the illustrated embodiment, a foreign object 418 is shown in the negative input image 416, which is used to train the image comparison tool 160 to highlight differences relating to foreign objects.

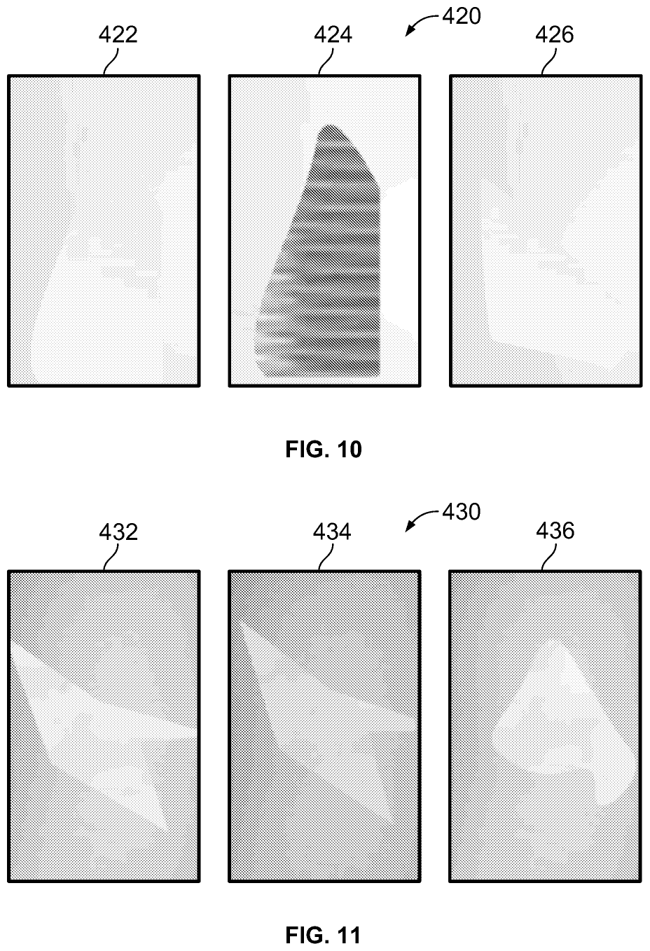

FIG. 10 illustrates a training data set 420 for training the terminal inspection module 150 using the image comparison tool 160 (shown in FIG. 7). The training data set 420 includes an anchor image 422, a positive (“good”) input image 424, and a negative (“bad”) input image 426.

In various embodiments, differences relating to the materials of the parts or the background structures between the input image 424 and the anchor image 422 may be ignored. In the illustrated embodiment, the material of the part is different in the positive input image 424, which is used to train the image comparison tool 160 to ignore differences relating to material of the part.

In various embodiments, differences relating to positional differences of the parts between the input image 424 and the anchor image 422 may be ignored. In the illustrated embodiment, the position of the part in the input image 424 is shown shifted slightly upward relative to the position of the part in the anchor image 422, which is used to train the image comparison tool 160 to ignore positional differences of the part relative to the background structure.

In various embodiments, differences relating to change in shape of the part in the input image may be important. In the illustrated embodiment, the part in the negative input image 426 has a different shape than the part in the anchor image 422, which is used to train the image comparison tool 160 to highlight differences relating to change in shape.

FIG. 11 illustrates a training data set 430 for training the terminal inspection module 150 using the image comparison tool 160 (shown in FIG. 7). The training data set 430 includes an anchor image 432, a positive (“good”) input image 434, and a negative (“bad”) input image 436.

In various embodiments, differences relating to the materials of the parts or the background structures between the input image 434 and the anchor image 432 may be ignored. In the illustrated embodiment, the material of the part is different in the positive input image 434, which is used to train the image comparison tool 160 to ignore differences relating to material of the part.

In various embodiments, differences relating to positional differences of the parts between the input image 434 and the anchor image 432 may be ignored. In the illustrated embodiment, the position of the part in the input image 434 is shown shifted slightly upward relative to the position of the part in the anchor image 432, which is used to train the image comparison tool 160 to ignore positional differences of the part relative to the background structure.

In various embodiments, differences relating to change in shape of the part in the input image may be important. In the illustrated embodiment, the part in the negative input image 436 has a different shape than the part in the anchor image 432, which is used to train the image comparison tool 160 to highlight differences relating to change in shape.

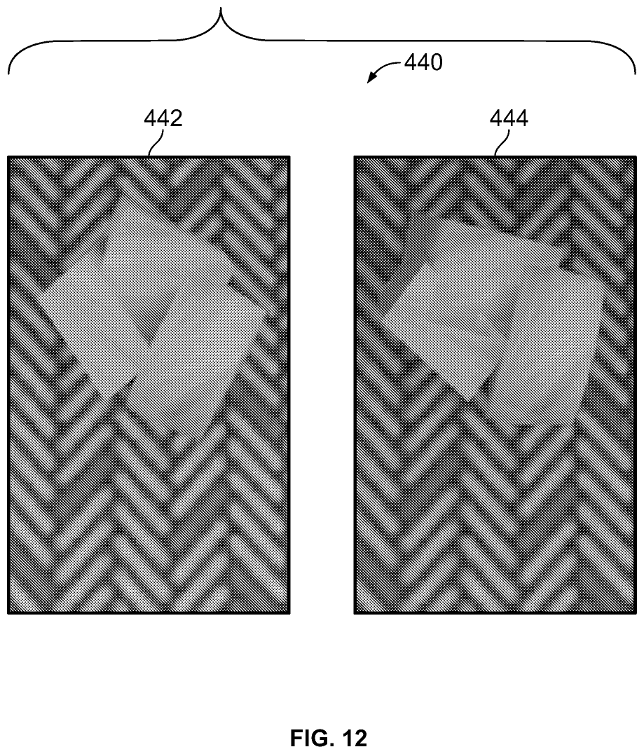

FIG. 12 illustrates a training data set 440 for training the terminal inspection module 150 using the image comparison tool 160 (shown in FIG. 7). The training data set 440 includes an anchor image 442 and an input image 444. In various embodiments, the training images used by the training module may be three-dimensional images. The angle of imaging may be similar to the angle used by the vision device 120 (shown in FIG. 2) to improve training for the crimp machine 200 (shown in FIG. 2).

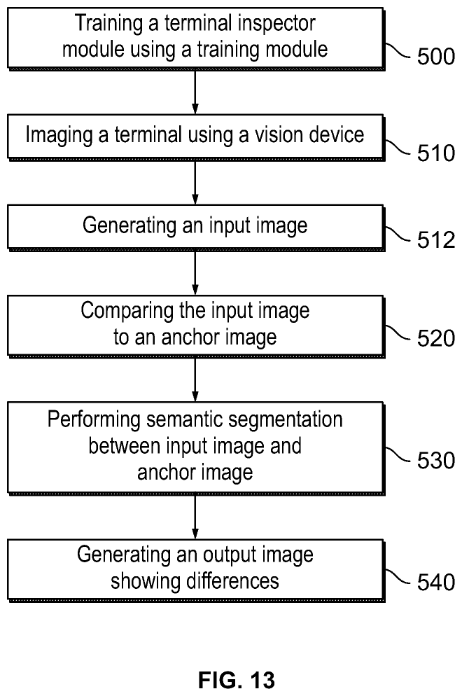

FIG. 13 is a flow chart of a terminal inspection method in accordance with an exemplary embodiment. The method includes training 500 a terminal inspection module of a controller using a training module. The training may be performed using a training data set to train the terminal inspection module. The training data set may include an anchor image, one or more positive/good images, and one or more negative/bad images. The training module may train the terminal inspection module to ignore differences relating to material differences between the input image and the anchor image. The training module may train the terminal inspection module to ignore differences relating to positional differences between the input image and the anchor image. The training module may train the terminal inspection module to identify differences relating to foreign objections identified in the input image. The training module may train the terminal inspection module to identify differences relating to differences in shapes between the terminal in the input image and the terminal in the anchor image. The training module may train the terminal inspection module using two-dimensional images. The training module may train the terminal inspection module using three-dimensional images.

The method includes imaging 510 a terminal using a vision device and generating 512 an input image. The vision device may include a camera imaging a crimp zone of a crimp machine. The input image may be an image of a terminal being inspected.

The method includes comparing 520 the input image to an anchor image. In an exemplary embodiment, the anchor image may be stored in memory and represents a “good” or ideal image. The anchor image may be an image of a terminal arranged in a crimp zone in various embodiments.

The method includes performing 530 semantic segmentation between the input image and the anchor image. The semantic segmentation may be performed by an image comparison tool, such as an artificial neural network architecture for image comparison. For example, the image comparison tool may include a U-net network architecture. The semantic segmentation may include a pixel-by-pixel comparison of the input image and the anchor image.

The method includes generating 540 an output image showing differences between the input image and the anchor image to identify any potential defects, if any defects are present. The output image is used to indicate to the user whether or not the terminal has any defects. The output image may highlight differences between the input image and the anchor image by displaying pixels without differences with a first color in the output image and displaying pixels with differences with a second color in the output image. In various embodiments, the output image may include overlaid defect identifiers, such as bounding boxes, at any identified defect locations. If no defects are detected, then the output image may not include any highlighted differences. For example, the entire output may be a single color, such as block.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A terminal inspection system for a crimp machine comprising:
a vision device configured to image a terminal being inspected and generate a digital image of the terminal;
a terminal inspection module communicatively coupled to the vision device and receiving the digital image of the terminal as an input image, the terminal inspection module having an anchor image, the terminal inspection module comparing the input image to the anchor image and performing semantic segmentation between the input image and the anchor image to generate an output image, the output image showing differences between the input image and the anchor image to identify any potential defects.

2. The terminal inspection system of claim 1, wherein the terminal inspection module uses an artificial neural network for the image comparison.

3. The terminal inspection system of claim 1, wherein the terminal inspection module directly compares the input image with the anchor image.

4. The terminal inspection system of claim 1, wherein the semantic segmentation performs a pixel-by-pixel comparison of the input image and the anchor image.

5. The terminal inspection system of claim 1, wherein the output image highlights differences between the input image and the anchor image by displaying pixels without differences with a first color in the output image and displaying pixels with differences with a second color in the output image.

6. The terminal inspection system of claim 1, wherein the terminal inspection module includes a U-net network architecture for comparing the input image and the anchor image and generating the output image.

7. The terminal inspection system of claim 1, wherein the terminal inspection module includes a training module using a training data set to train the terminal inspection module, the training data set including the anchor image, a plurality of positive images, and a plurality of negative images.

8. The terminal inspection system of claim 1, wherein the terminal inspection module includes a training module training the terminal inspection module to ignore differences relating to material differences between the input image and the anchor image.

9. The terminal inspection system of claim 1, wherein the terminal inspection module includes a training module training the terminal inspection module to ignore differences relating to positional differences between the input image and the anchor image.

10. The terminal inspection system of claim 1, wherein the terminal inspection module includes a training module training the terminal inspection module to identify differences relating to foreign objections identified in the input image.

11. The terminal inspection system of claim 1, wherein the terminal inspection module includes a training module training the terminal inspection module to identify differences relating to differences in shapes between the terminal in the input image and the terminal in the anchor image.

12. The terminal inspection system of claim 1, wherein the terminal inspection module includes a training module for training the terminal inspection module, the images used by the training module being two-dimensional images.

13. The terminal inspection system of claim 1, wherein the terminal inspection module includes a training module for training the terminal inspection module, the images used by the training module being three-dimensional images.

14. A crimp machine comprising:
an anvil having a terminal support surface at a crimp zone configured to support a terminal during a crimping operation;
a press having an actuator, a ram operably coupled to the actuator, and a crimp die coupled to the ram, the actuator moving the ram in a pressing direction during the crimping operation to move the crimp die relative to the anvil, the crimp die having a forming surface configured to crimp the terminal in the crimp zone during the crimping operation; and
a terminal inspection system including a vision device and a terminal inspection module communicatively coupled to the vision device, the vision device configured to image the terminal at the crimp zone and generate a digital image of the terminal, the terminal inspection module receiving the digital image of the terminal as an input image, the terminal inspection module having an anchor image, the terminal inspection module comparing the input image to the anchor image and performing semantic segmentation between the input image and the anchor image to generate an output image, the output image showing differences between the input image and the anchor image to identify any potential defects.

15. A terminal inspection method comprising:
imaging a terminal using a vision device to generate an input image;
comparing the input image to an anchor image;
performing semantic segmentation between the input image and the anchor image;
generating an output image showing differences between the input image and the anchor image to identify any potential defects.

16. The terminal inspection method of claim 15, wherein said comparing the input image to the anchor image comprises a pixel-by-pixel comparison of the input image and the anchor image.

17. The terminal inspection method of claim 15, wherein the output image highlights differences between the input image and the anchor image by displaying pixels without differences with a first color in the output image and displaying pixels with differences with a second color in the output image.

18. The terminal inspection method of claim 15, wherein said comparing the input image to the anchor image comprises processing the input image and the anchor image through a U-net network architecture.

19. The terminal inspection method of claim 15, further comprising training a terminal inspection module used for the image comparison and the output image generation, said training comprising:
training the terminal inspection module to ignore differences relating to material differences between the input image and the anchor image;
training the terminal inspection module to ignore differences relating to positional differences between the input image and the anchor image;
training the terminal inspection module to identify differences relating to foreign objections identified in the input image; and
training the terminal inspection module to identify differences relating to differences in shapes between the terminal in the input image and the terminal in the anchor image.

20. The terminal inspection method of claim 15, further comprising training a terminal inspection module used for the image comparison and the output image generation, said training including training the terminal inspection module using three-dimensional images.
